(19) United States
(12) Patent Application Publication
(10) Pub. No.: US 2016/0359362 A1
(43) Pub. Date: Dec. 8, 2016

(54) Fast Restart Of Flywheel In Uninterruptible Power Supply System Having Flywheel System/Battery Combination

(71) Applicant: Liebert Corporation, Columbus, OH (US)

(72) Inventor: James K. MARTIN, Galena, OH (US)

(21) Appl. No.: 15/142,570

(22) Filed: Apr. 29, 2016

Related U.S. Application Data
(60) Provisional application No. 62/171,660, filed on Jun. 5, 2015.

(51) Int. Cl. H02J 9/08; H02J 7/00; H02J 9/06

(52) U.S. Cl. CPC H02J 9/08; H02J 9/061; H02J 7/0013

(57) ABSTRACT

An uninterruptible power supply system has a flywheel system/battery combination as a source of back-up DC power. When power is restored after a power outage, a controller of the uninterruptible power supply system controls the rectifier to keep its DC output voltage sufficiently low so that only the flywheel system of the flywheel system/battery combination is initially recharged. Once the flywheel system is recharged, the controller is configured to raise the voltage of the rectifier's DC output voltage to the nominal DC output voltage of the rectifier, both for recharging the battery pack of the flywheel system/battery combination and to provide DC power to an inverter of the uninterruptible power supply system.

### CROSS-REFERENCE TO RELATED APPLICATIONS

This application claims the benefit of U.S. Provisional Application No. 62/171660, filed on Jun. 5, 2015. The entire disclosure of the above application is incorporated herein by reference.

### FIELD

The present disclosure relates to uninterruptible power supply systems having a flywheel system/battery combination.

### BACKGROUND

This section provides background information related to the present disclosure which is not necessarily prior art.

Many uninterruptible power supply systems have both a battery pack and a flywheel system for providing back-up direct current power. “Direct current” is sometimes referred to herein as “DC.” They provide the back-up DC power for the UPS system during a loss of AC input power, such as a loss of AC power from an electric utility company. The flywheel system is used for short term outages so the battery pack life is not reduced due to short repetitive discharge/recharge cycles. During short term outages, the flywheel system supplies the back-up DC power and not the battery pack.

FIG. 1 is a simplified block diagram of a typical prior art uninterruptible power supply system 100 having a flywheel system/battery combination for providing back-up DC power. Uninterruptible power supply system 100 will sometimes be referred to herein as UPS system 100 with “UPS” meaning “uninterruptible power supply.” The basic elements of UPS system 100 are rectifier 102, inverter 104, flywheel system/battery combination 106, a controller 108, and a static transfer switch 110. Rectifier 102 is coupled to a source of alternating current power (not shown) such as to a utility substation, directly or via an intermediary input transformer (not shown), and converts the AC power to DC power that it provides to a DC bus 112. “Alternating current” is sometimes referred to herein as “AC.” Inverter 104 converts the DC power on the DC bus 112 to AC power that it provides to an output 114 of UPS system 100. directly or through an intermediary output transformer (not shown). Static transfer switch is coupled between a source of AC power, such as a utility substation (not shown) and output 114 of UPS system 100. Flywheel system/battery combination 106 is coupled to DC bus 112 and provides back-up DC power to DC bus 112 and thus to inverter 104 in the event of a power failure of the AC power source coupled to rectifier 102. Flywheel system/battery combination 106 has a battery pack 116 coupled to DC bus 112 and a flywheel system 118 that is also coupled to DC bus 112. Flywheel system 118 includes DC/DC converter 120, motor/generator 122 and flywheel 124. DC/DC converter couples motor/generator windings (not shown) of motor/generator 122 to DC bus 112 and flywheel 124 is coupled to a rotor (not shown) of motor/generator 122.

Controller 108 is configured to control UPS system 100 including rectifier 102 and inverter 104 by varying the duty cycle of the power switching devices in rectifier 102 so that rectifier 102 provides a desired DC output voltage to DC bus 112, and also in inverter 104 so that inverter 104 provides a desired AC output voltage. Controller 108 also controls static transfer switch 110 to cause it to switch between closed and open. Controller 108 can be, be part of, or include: an Application Specific Circuit (ASIC); an electronic circuit; a combinational logic circuit; a field programmable gate array (FPGA); and/or a processor such as a Digital Signal Processor (DSP), microcontroller, or the like. It should be understood that controller 108 may include one or ore than one of the foregoing, such as digital controller based on DSPs that control each of the functional blocks of UPS system 100 by generating the proper switching signals to switch the power switching devices, such IGBTs and thyristors.

During normal operation, the motor/generator 122 is operating as a motor and is powered by the DC 112 bus of the UPS system 100 to spin the flywheel 124 to full speed. When there is a power failure, the motor/generator 122 operates as a generator and the flywheel 124 spins the rotor 125 of motor/generator 122 so that the motor/generator 122 generates DC electric power that is provided to DC bus 112 via DC/DC converter 120.

Typically upon power being restored from the AC utility after a power outage, the rectifier of the UPS supplies current to raise the DC bus to charge the battery pack and also the flywheel system. The DC bus “charges” the flywheel system by powering the motor/generator to bring the flywheel back to full speed. Since the rectifier is charging both the battery pack and the flywheel system, it takes longer for the flywheel system to achieve full recharge. In addition there is a limited amount of energy available from the rectifier. The rectifier must supply the load power for the UPS and also the charging system power for the flywheel system and battery pack. This becomes a greater issue the more the system is loaded.

### SUMMARY

This section provides a general summary of the disclosure, and is not a comprehensive disclosure of its full scope or all of its features.

In accordance with an aspect of the present disclosure, an uninterruptible power supply system has and includes a method of providing fast restart of a flywheel of a flywheel system/battery combination. The uninterruptible power supply system includes a rectifier, a direct current bus, an inverter, a flywheel system/battery combination and a controller. The flywheel system/battery combination has a battery pack and a flywheel system. The flywheel system has a motor/generator having a rotor to which the flywheel is mechanically coupled. An output of the rectifier is electrically coupled to the direct current bus. An input of the inverter is electrically coupled to the direct current bus. The battery pack is electrically coupled to the direct current bus and the motor/generator is electrically coupled to the direct current bus. The controller is configured with control logic to fast restart the flywheel upon input power being restored to the uninterruptible power supply system after a power interruption of input power to the uninterruptible power supply system by controlling the rectifier to control a direct current output voltage of the rectifier to first recharge the flywheel system and after the flywheel system has been recharged, then recharging the battery pack.

In accordance with an aspect, to first recharge the flywheel system and then recharge the battery pack the controller is configured with control logic to control the direct current output voltage of the rectifier to provide a direct current output voltage to the direct current bus at a first voltage level that is high enough to recharge the flywheel system but not high enough charge the battery pack and upon the controller determining that the flywheel system is fully recharged, the controller configured with control logic to control the rectifier to raise the direct current output voltage of the rectifier to a second voltage level high enough to recharge the battery pack. In accordance with an aspect, the first voltage level is a voltage level at which the motor/generator runs at a nominal maximum rated speed of the motor/generator. In accordance with an aspect, the second voltage level is a nominal maximum rated output voltage of the rectifier.

In accordance with an aspect, the controller is configured with control logic to be responsive to a speed sensor that senses a speed at which the rotor of the motor/generator is rotating and the controller is configured with control logic to determine that the flywheel system has been recharged when the flywheel has reached a full speed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a basic block diagram of a prior art uninterruptible power supply system having a flywheel system/battery combination as a source of back-up DC power;

FIG. 2 is a flow chart showing a control routine in accordance with an aspect of the present disclosure for controlling a rectifier of the uninterruptible power supply system of FIG. 1 for fast restart of the flywheel of the flywheel system/battery combination; and

FIG. 3 is a basic block diagram of an uninterruptible power supply system having a flywheel system/battery combination as a source of back-up DC power with fast restart of the flywheel in accordance with FIG. 2.

Corresponding reference numerals indicate corresponding parts throughout the several views of the drawings.

### DETAILED DESCRIPTION

Example embodiments will now be described more fully with reference to the accompanying drawings.

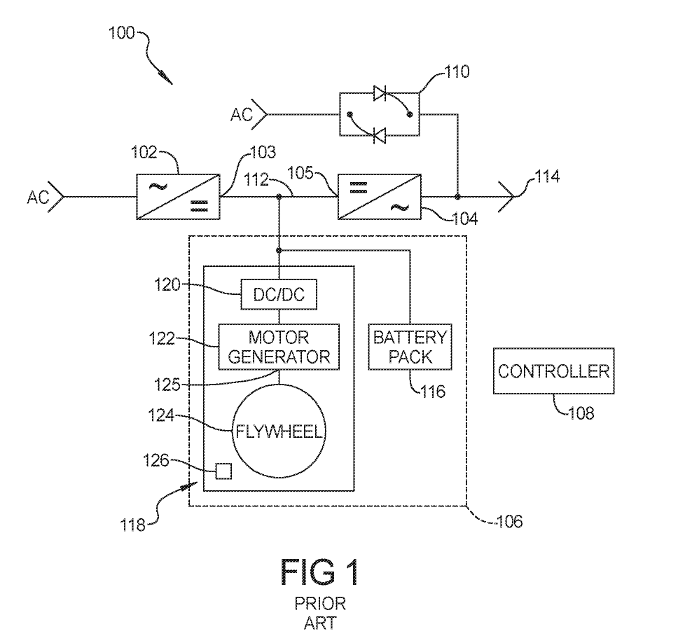

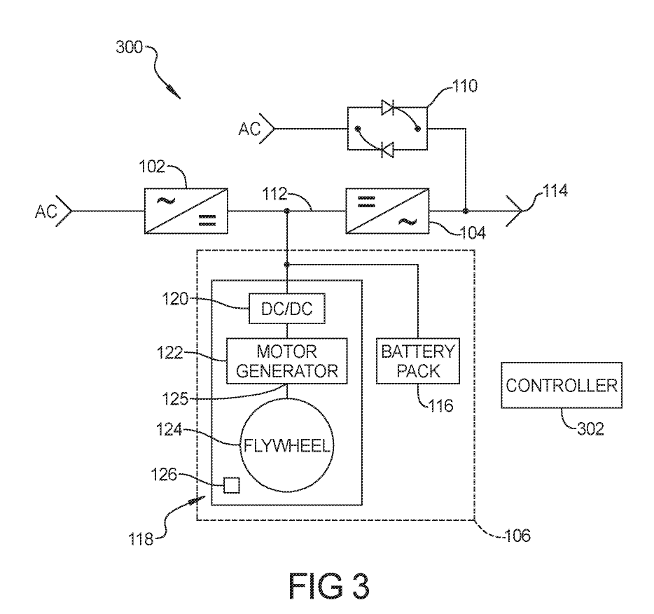

In accordance with an aspect of the present disclosure, control of a DC output voltage of a rectifier of an uninterruptible power supply system having a flywheel system/battery combination 106 to provide fast restart of the flywheel is described with reference to uninterruptible power supply system 300 of FIG. 3. Uninterruptible power supply system 300 will sometimes be referred to herein as UPS system 300 with “UPS” meaning “uninterruptible power supply.” UPS system 300 is the same as UPS system 100 of FIG. 1 with the exception of the control implemented in controller 302 to provide fast restart of flywheel 124 in flywheel system 118 and other than for this control, controller 302 is otherwise the same as controller 108 of FIG. 1.

In accordance with an aspect of the present disclosure, once power is restored after a power outage, controller 302 is configured to control a direct current output voltage of rectifier 102 to provide fast restart of flywheel 124. “Direct current” may sometimes be referred to herein as “DC.” It does so by controlling rectifier 102 so that the voltage level of the DC output voltage of rectifier 102 is kept at a level that is high enough to recharge flywheel system 118 but not high enough to recharge battery pack 116. It should be understood that the DC output voltage not being high enough to recharge the battery pack 116 means that it is not high enough to charge battery pack 116 to any appreciable degree so that the power drawn in any recharging of battery pack 116 at this point is nominal compared to the power being used to recharge flywheel system 118. As used herein, recharging flywheel system 118 means running motor/generator 122 as a motor to bring flywheel 124 back to its nominal full speed. Once flywheel system 118 is recharged, the controller 108 is configured to raise the voltage of the rectifier output to its nominal DC output voltage, both for recharging battery pack 116 of flywheel system/battery combination 106 and to provide DC power to DC bus 112. This makes flywheel system 118 available sooner to provide back-up DC power in the event of any subsequent temporary AC input power and in prior art UPS systems in which the flywheel system 118 and battery pack 116 are recharged as the same time. It also avoids short repetitive discharge/recharge cycles of the battery pack 116 and thus extends battery life of the batteries in battery pack 116.

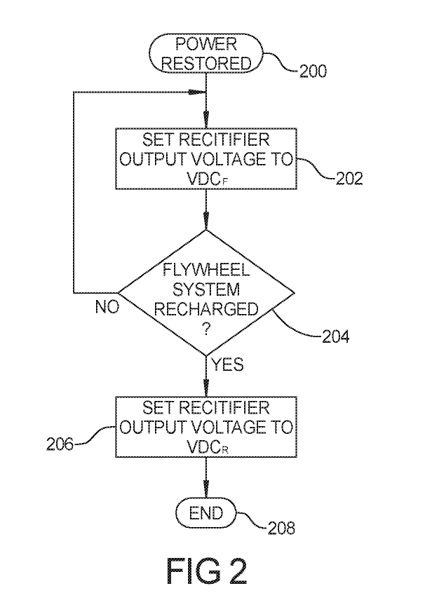

FIG. 2 is a flow chart of an example control routine for controlling rectifier 102 for fast restart of flywheel system 118 as discussed above. Illustratively, controller 302 is configured to implement this control routine, such as being programmed with software that executes this control routine. The routine starts at 200 after power is restored after a power outage. At 202, the DC output voltage of rectifier 102 is controlled so that it is at a high enough level to recharge flywheel system 118 but not to charge battery pack 116 to any degree. This DC output voltage is referred to herein as VDC_{F} and for example is the nominal voltage for running motor/generator 122 of flywheel system 118 as a motor, for example, 400 VDC. In contrast, the nominal output voltage of rectifier 102 is 540 VDC, referred to herein as VDC_{R}. At 204, the routine checks whether flywheel system 118 has been recharged, that is, whether flywheel 124 has been brought back to full speed. In an example, a speed sensor 126 that senses the speed of flywheel 124, such as an RPM sensor, communicates the speed of flywheel 124 to controller 108. If flywheel system 118 has not been fully recharged, the routine branches back to 202. If flywheel system 118 has been fully recharged, the routine proceeds to 206 where the DC output voltage of rectifier 102 is controlled so that it is at the nominal DC output voltage of rectifier 102, 540 VDC as discussed above. The routine then ends at 208.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of fast restart of a flywheel in an uninterruptible power supply system having a flywheel system/battery combination upon input power being restored after a power interruption, the flywheel system/battery combination having a battery pack and a flywheel system, the flywheel system having a motor/generator having a rotor to which the flywheel is mechanically coupled, the motor/generator electrically coupled to a direct current bus of the uninterruptible power supply system and the battery pack electrically coupled to the direct current bus, the method comprising:
upon input power being restored to the uninterruptible power supply system after a power interruption of the input power to the uninterruptible power supply system controlling a rectifier of the uninterruptible power supply system with a controller of the uninterruptible power supply system to control a direct current output voltage of the rectifier to first recharge the flywheel system and not recharging the battery pack during recharging of the flywheel system and upon the flywheel system being fully recharged then recharging the battery pack.

2. The method of claim 1 wherein to first recharge the flywheel system and then recharge the battery pack, controlling the direct current output voltage of the rectifier with the controller to provide a direct current output voltage to the direct current bus at a first voltage level that is high enough to recharge the flywheel system but not high enough charge the battery pack and upon the controller determining that the flywheel system is fully recharged, controlling the rectifier with the controller to raise the direct current output voltage of the rectifier to a second voltage level high enough to recharge the battery pack.

3. The method of claim 2 wherein controlling the direct current output voltage of the rectifier with the controller to provide the direct current output voltage to the direct current bus at the first voltage level includes controlling the direct current output voltage of the rectifier with the controller to provide the direct current output voltage to the direct current bus at a voltage level at which the motor/generator runs at a nominal maximum rated speed of the motor/generator.

4. The method of claim 3 wherein controlling the direct current output voltage of the rectifier with the controller to provide the direct current output voltage to the direct current bus at the second voltage level includes controlling the direct current output voltage of the rectifier with the controller to provide the direct current output voltage to the direct current bus at a voltage level that is a nominal maximum rated output voltage of the rectifier.

5. The method of claim 2 including having the controller responsive to a speed sensor that senses a speed at which the rotor of the motor/generator is rotating and determining with the controller hat the flywheel system has been recharged when the flywheel has reached a full speed based on the speed of the rotor sensed by the speed sensor.

6. An uninterruptible power supply system having fast restart of a flywheel of a flywheel system/battery combination, comprising:
a rectifier, a direct current bus, an inverter, a flywheel system/battery combination and a controller;
the flywheel system/battery combination having a battery pack and a flywheel system, the flywheel system having a motor/generator having a rotor to which the flywheel is mechanically coupled;
an output of the rectifier electrically coupled to the direct current bus, an input of the inverter electrically coupled to the direct current bus, the battery pack electrically coupled to the direct current bus and the motor/generator electrically coupled to the direct current bus; and
the controller configured with control logic to fast restart the flywheel upon input power being restored to the uninterruptible power supply system after a power interruption of the input power to the uninterruptible power supply system by controlling the rectifier to control an direct current output voltage of the rectifier to first recharge the flywheel system and after the flywheel system has been recharged, then recharging the battery pack.

7. The uninterruptible power supply system of claim 6 wherein to first recharge the flywheel system and then recharge the battery pack the controller is configured with control logic to control the direct current output voltage of the rectifier to provide a direct current output voltage to the direct current bus at a first voltage level that is high enough to recharge the flywheel system but not high enough charge the battery pack and upon the controller determining that the flywheel system is fully recharged, the controller configured with control logic to control the rectifier to raise the direct current output voltage of the rectifier to a second voltage level high enough to recharge the battery pack.

8. The uninterruptible power supply system of claim 7 wherein the first voltage level is a voltage level at which the motor/generator runs at a nominal maximum rated speed of the motor/generator.

9. The uninterruptible power supply system of claim 8 wherein the second voltage level is a nominal maximum rated output voltage of the rectifier.

10. The uninterruptible power supply system of claim 7 wherein the controller is configured with control logic to be responsive to a speed sensor that senses a speed at which the rotor of the motor/generator is rotating and the controller is configured with control logic to determine that the flywheel system has been recharged when the flywheel has reached a full speed.
